(19) United States
(12) Patent Application Publication
(10) Pub. No.: US 2007/0078629 A1
(43) Pub. Date: Apr. 5, 2007

(54) Distributed control system diagnostic logging system and method

(76) Inventors: Neil Gollhardt, Fox Point, WI (US); Wayne H. Wielebski, New Berlin, WI (US)

Correspondence Address: ROCKWELL AUTOMATION, INC./(FY), ATTENTION: SUSAN M. DONAHUE, 1201 SOUTH SECOND STREET, MILWAUKEE, WI, 53204, US

(21) Appl. No.: 11/241,018

(22) Filed: Sep. 30, 2005

(51) Int. Cl. G06F 15/00

(52) U.S. Cl. 702/183

(57) ABSTRACT

A logging system is provided for a distributed automation application, such as an on-machine motor controller or the like. The logging system can access raw data, processed data, event data, error data, and so forth from a controller local to the applicational power to a load, such as an electric motor. The logging system can also access information and place information on a network to which the controller is linked. Logging system may also monitor and log data directly from sensors. Information and data stored in logging system may be interrogated and accessed either remotely via a network, or locally, such as through a local access port.

### BACKGROUND

The present invention relates generally to the field of industrial automation and control systems. More particularly, the invention relates to a data logging module that can be incorporated into such systems for enhancing distributed and local control and monitoring by storing event logs and similar support data.

A wide range of applications exist for automation and control systems, particularly in industrial settings. Such applications may include the powering of a wide range of actuators, such as valves, electric motors, and so forth, and the collection of data via sensors. Traditional approaches to factory automation, for example, have included relatively centralized switch gear and controllers that may be networked to provide automation functions. These functions may be programmed into the controllers and command signals applied to the actuators, and feedback signals from the sensors can be stored for processing and analysis. In traditional systems, such processing and analysis, including the creation of error logs and event logs has taken place at a centralized location. Such centralized locations may, for example, in motor drives consist of large enclosures or cabinets in which various protective devices, switch gear, controllers and the like are disposed. Conduits typically extend considerable distances between these locations and the various machine points at which actuators and sensors are located.

There is increasing interest in automation technologies for more localized control and monitoring. Such approaches tend to form distributed systems in which certain protected circuits, switch gear and controllers are located fairly close to the loads that they command or monitor. In complex machine systems, for example, there is an increasing interest in locating motor drives and their associated circuitry quite close to the locations of the motors themselves. Because many such motors and actuators may be located in a complex process, many individual and distributed controllers may be positioned in various locations around the process machinery.

One advantage in the provision of distributed systems, which may be referred to as “on-machine” systems, is their ability to localize certain control decisions without reverting to command and control from a centralized location. Depending upon the system design, the distributed on-machine systems may function more or less autonomously, reporting only certain events and accepting only certain commands from a centralized location. At one extreme, such distributed systems work completely autonomously, and may not even be networked to a central system. In all of the various solutions of this type, one weakness is the inability or difficulty in centralizing logging of events, errors, malfunctions, or even normal operating parameters. Indeed, it would be advantageous to provide an automation control and monitoring system that has little or no need to maintain centralized logs of events, errors and operating parameters, but that can do so more locally and in a distributed manner, similar to the topology of the distributed control or monitoring systems themselves. To date, however, such on-machine systems do not incorporate logging circuitry of this type.

### BRIEF DESCRIPTION

The invention provides a novel approach to logging of events, errors, and operating parameter data designed to respond to such needs. The invention provides, for example, what may be thought of as a “black box” for maintaining such data, but located locally at a distributed control or monitoring station in an automation setting. The distributed stations or controllers may be linked to one another by a network, and may be linked to centralized stations, computers, and so forth. In general, however, the distributed stations and controllers will be physically dispersed from one another and may conveniently be located proximate to points at which automation is controlled or monitored.

The logging circuitry provided in the distributed stations or controllers may be linked to the controllers themselves, and may also monitor traffic over a network linking such controllers, where desired. The logging circuitry may also be tied to sensors directly, so as to detect sensed parameters independent of their application to a network. The logging devices can log raw data or process the data to extract relationships that could be indicative of certain events, malfunctions, and so forth. Moreover, among the data logged in the devices, various events and errors that are flagged by the control systems themselves can be monitored, acquired and stored. The logging devices may then output such information either remotely, such as via a network link, or via a separate access port. Ideally, the data logging devices operate virtually independently of the controllers, such that the data logging functions do not rely upon the controllers directly, but may even serve to evaluate the operative state of the controllers themselves.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical representation of an exemplary control and monitoring system incorporating a data logging technique in accordance with aspects of the present invention;

FIG. 2 is a diagrammatical representation of certain functional components in an exemplary data logging system and associated controller; and

FIG. 3 is a diagrammatical representation of certain of functional components that might be included in a data logging system of the type co-located with the controller of FIG. 2.

### DETAILED DESCRIPTION

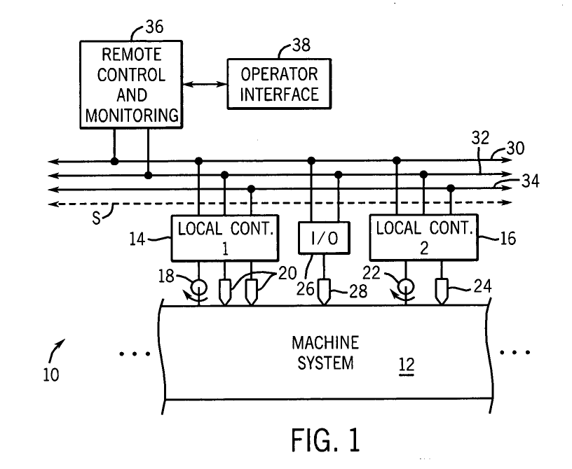

Turning now to the drawings, and referring first to FIG. 1, a control and monitoring system is illustrated and designated generally by reference numeral 10. System 10 includes various components for applying electrical power to a machine system, represented generally at reference numeral 12. As will be appreciated by those skilled in the art, the machine system 12 may be any of a wide range of machine systems having powered loads and points at which certain sensed data is collected for control and monitoring purposes. Examples of such machines systems in industrial settings might include manufacturing processes, assembly lines, material handling and conveyers, chemical process controls, fluid handling systems, and so forth. However, the present techniques are not intended to be limited to any particular type of machine system.

The control and monitoring system 10, as illustrated, includes a range of local controllers 14 and 16 that are located in the general vicinity of points where power is applied to the machine system 12 or where data is collected. The local controllers 14 and 16 may carryout a wide range of functions, such as for starting and stopping loads, such as electric motors, regulating application of power to the loads, sensing application of power to the loads, sensing parameters of the process to which the loads are applied, and so forth. In the illustrated example, local controller 14 controls a motor 18, and interfaces with a pair of sensors 20. The sensors may, for example, sense the performance of the motor 18 or may sense other machine parameters, such as elevations, speeds, vibration, the presence of a work piece, and so forth, to name only a few. Similarly, local controller 16 controls application and power to a motor 22, and interfaces with a sensor 24. As will be appreciated by those skilled in the art, many such controllers may be provided in a typical large machine system or process, and each local controller may be interfaces with a range of actuators and sensors. The system also includes stand-alone I/O modules as illustrated at reference numeral 26 that may be used to interface with other actuators and sensors, such as sensor 28.

The controllers 14 and 16, and I/O module 26 are coupled to power and data busses that provide for application of power to the loads, provision of control power, and exchange of network data. In the illustrated embodiment, a data bus 30 is coupled to each of the controllers and I/O module to exchange sensed and control data in accordance with a suitable protocol. By way of example, in an industrial setting, known protocols might include the DeviceNet protocol. A control power bus 32 is provided and coupled to the controllers for providing control power. As will be appreciated by those skilled in the art, control power generally is either ac or dc power (e.g., 110 vac or 24 vdc) that enables switching devices, actuators, and sensors to perform their tasks.

In general, in many applications it is desired to provide control power that can be independently switched from the power applied to the loads, permitting testing and servicing of the controllers without power actually being applied to the loads. Similarly, a power bus 34 is provided for distribution of the power to be applied to the loads. In a typical industrial setting, the power bus will include four conductors for three-phase power and a ground. A neutral conductor may also be provided in the bus, were desired. The invention is not, however, limited to the application of three-phase power, but is equally applicable to systems distributing single-phase power.

In certain settings, a supplementary bus which may be referred to as an E-stop bus, represented by the dashed line capital S may also be provided. As will be appreciated by those skilled in the industrial arts, E-stop circuits (a term coined to refer to “emergency stop” circuits) are provided for interrupting power to certain loads in the event of the need for a rapid removal of power. In many settings, an E-stop bus will be interfaced with conspicuous push buttons to allow personnel to positively stop a process when needed.

While the local controllers may generally function virtually completely independently, in many settings it may be desirable to convey control and monitoring signals between these controllers and remote control and monitoring equipment. For example, in an industrial setting, such equipment may include programmable logic controllers, remote computer systems, various associated controllers in control rooms or control locations, and so forth. One such remote control and monitoring system 36 is illustrated in FIG. 1 as coupled to the data bus 30 and to the control power bus 32. As will be appreciated by those skilled in the art, such monitoring and control equipment may include operator interfaces 38 of various types. Such operator interfaces may include conventional computer monitors, keyboards, by-hand input devices, and the like. In certain settings, moreover, the interfaces will include human machine interfaces (HMIs) dedicated for the particular process to be controlled. It should be also noted that such operator interfaces may be provided at each local controller 14 and 16, where desired.

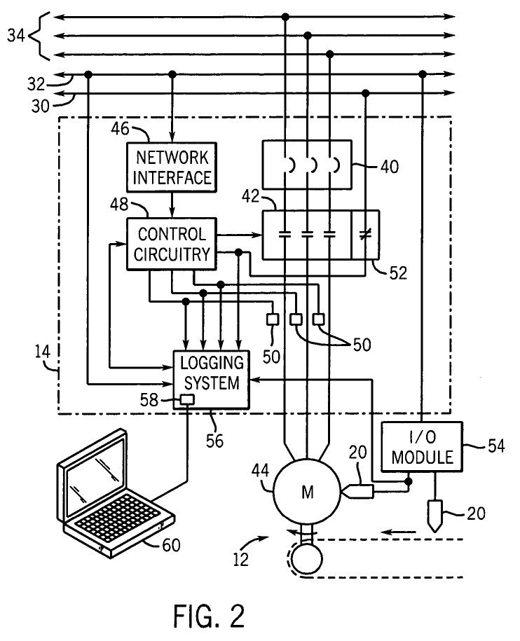

Exemplary components of a local controller 14 or 16 that includes a data logging system in accordance with the present invention are illustrated in FIG. 2. As noted above, controller 14 is coupled to data and control power busses 30 and 32, and to application power busses 34, such as for application of three-phase to a load. In the illustrated embodiment, in a sealed enclosure, the controller 14 might include protective circuitry 40, such as fuses. Electrically downstream of the fuses the controller includes a contactor 42 for providing three-phase power, in this case, to a load in the form of a motor 44. By way of example, the motor may serve to turn a pulley for a conveyer. It should be noted, however, that the present techniques are not intended to be limited to any particular application, or even to use with motors as actuators.

The controller 14 is also coupled to the network bus 30 to exchange signals with the bus in accordance with any appropriate protocol, in a presently contemplated embodiment a DeviceNet protocol, an industry standard for open industrial data exchange networks. The network interface 46 will typically include hardware and software for converting memory or register values to appropriate messages, applying such messages to the network, receiving similar messages from the network and translating them for use in the controller. Such messages are applied to and may originate from control circuitry 48. Control circuitry 48 may typically include a motor drive, a motor starter, a programmable logic controller, or any other programmable or programmed logic devices. The control circuitry will also typically include memory for storing a program to be carried out by the controller, and for storing values either used as a basis for control, or sensed values used in control or monitoring functions. The control circuitry 48 may command operation of the contactor 42, for example, used to supply power to the motor 44.

Various sensing and feedback devices will also typically be included in controller 14. For example, in the illustrated embodiment, current sensors 50 sense current through conductors providing power to the motor. Signals from such sensors are applied to the control circuitry 48 and may be used for control and monitoring functions. For example, control circuitry 48 may implement a particular control regime for torque or speed control of the motor, and use feedback from sensors 54 for implementation of the algorithms that form the basis of such control. Moreover, feedback from the sensors may be used to detect errors, such as a loss of phase, phase-to-phase shorts, phase-to-ground faults, and so forth. The control circuitry 48 may, in turn, interpret such sensed parameters and create or store event data, error logs, and so forth based upon the evaluation.

Similarly, other sensed data may be applied to the control circuitry 48. For example, contactor 42 may have an auxiliary contact 52 associated with it. The auxiliary contact will typically provide a low level logic signal to indicate that the contactor is either opened or closed, depending on whether the contactor and the auxiliary contact are wired as normally-opened or normally-closed devices. As will be appreciated by those skilled in the art, the auxiliary signal may be interpreted by the control circuitry as an indication of the operative state of the contactor 42. That is, if a control signal is being applied to energize the contactor, or the signal has been removed so as to de-energize the contactor, the auxiliary signal from the contact 52 provides an indication of whether the contactor has actually responded to the application or removal or the control signal.

Moreover, certain input signals can be received through an I/O module 54, such as coupled to sensors 20. The I/O module typically converts these signals to a useful format, such as for application to the data network bus 30.

As illustrated in FIG. 2, a logging system 56 is provided integral to or collocated with the controller. That is, while the logging system may operate autonomously from the controller, it may be located in a common enclosure or package. In a presently contemplated embodiment, the logging system would be incorporated in the same sealed enclosure as the other controller components described above.

The logging system may monitor, receive or request certain controller monitored signals from a range of sources, process these or store them in a raw form for later access and evaluation. For example, as illustrated in FIG. 2, the logging system 56 is coupled to the control circuitry 48 and may either receive certain signals directed from the control circuitry to the logging system, or simply monitor certain registers in the control circuitry memory for values that can be copied and processed for storage in the logging system. Similarly, the logging system may monitor traffic over the data network 30. Such traffic may include parameter values, command instructions, feedback signals, and so forth for both the location at which the controller is positioned, and for other locations, including from a remote controller on the network. Similarly, the logging system may monitor various sensed parameters directly from the sensors. In the embodiment illustrated in FIG. 2, for example, the logging system 56 monitors signals from the current sensors 50, as well as from the auxiliary contact 52 and from one of the sensors at the load.

As described in greater detail below, the logging system 56 may process such signals, such as to evaluate conditions such as faults, alarm conditions, errors, or simply to store parameters of interest. As also described below, the logging system 56 may periodically apply certain signals detected and stored therein to the network for remote monitoring and evaluation. Such signals may result, for example, in an alarm, a notification, or the like. The logging system may also be available for interrogation either remotely or locally. As illustrated in FIG. 2, for example, a local access port 56 may be provided, such as a serial or an Ethernet port for access to the logged information via a human interface device, such as a personal computer 60.

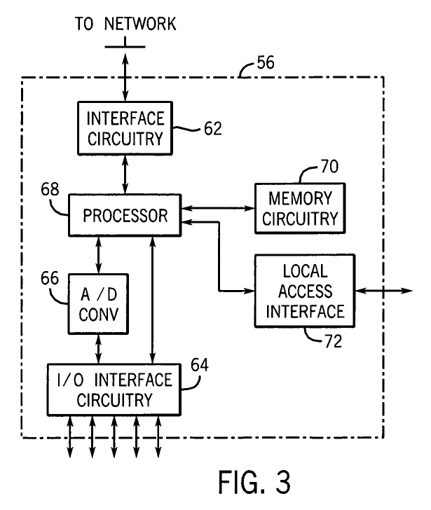

FIG. 3 represents exemplary components that may be included in a logging system 56. As noted above, the logging system will typically be configured to interface with a network, such an industrial control and monitoring network. Accordingly, interface circuitry 62 may be included in the logging system for applying signals and messages to the network and for extracting signals and messages from the network. Similarly, an I/O interface 64 may be included for receiving signals directly from sensors and other devices. Where these signals are digital, they can be supplied directly to the processor 68 of the logging system 56. For analog monitored signals, the logging system 56 may include an analog-to-digital converter 66 which converts the I/O signals for application to the processor.

The processor 68 may receive signals, event logs, error logs, and other data and processes data to identify certain error or fault conditions. For example, as will be appreciated by those skilled in the art, programming within the logging system may provide for comparing certain signals for identifiable fault sequences, comparison of signals values to fault values, error values, acceptable ranges, and so forth for generation of fault and error signals. Various other processing functions may be carried out by processor 68. Ultimately, then, the logged parameter, event and error data is stored in memory circuitry 70. The memory circuitry is preferably non-volatile memory such that in the event of a loss of power, the logged data can be recovered and evaluated.

Finally, as noted above, the logging system 56 preferably provides for local access to logged data. Accordingly, a local access interface 72 is provided to interface with processor 68 to pass data requests to the processor for extraction from memory, to load information into the logging system, where appropriate, and to convert any signals to a protocol needed for output to a local access device, such as a personal computer, hand-held computer, human machine interface, and so forth.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An on-machine diagnostic logging system comprising:
interface circuitry for receiving control and monitoring signals from machine control devices that control or monitor operation of a machine system;
a processor for receiving the control and monitoring signals from the interface and for processing the signals at least partially independently of a remote control and monitoring system; and
a memory circuit for storing the control and monitoring signals received by the processor;
wherein a subset of the control and monitoring signals are transmitted to the remote control and monitoring system, and the diagnostic logging system receives and stores signals not part of the subset, and wherein the interface circuitry is configured to be interrogated for access to control and monitoring signals stored in the memory circuit.

2. The system of claim 1, wherein the interface circuitry is configured to be coupled to a network and to monitor signals on the network for extraction of the control and monitoring signals to be stored in the memory circuit.

3. The system of claim 1, wherein the interface circuitry is addressable via a network for remote access to the control and monitoring signals stored in the memory circuit.

4. The system of claim 1, wherein the interface circuitry is configured to receive analog control or monitoring signals applied to or sensed from a controlled machine system.

5. The system of claim 1, wherein the processor is configured to perform analysis of the received control and monitoring signals to determine fault or error conditions in the controlled machine system.

6. The system of claim 1, wherein the system is configured to log signals passively only without communication of output or control signals to the controlled machine system.

7. The system of claim 1, wherein the system is disposed in a tamper-proof module coupled locally to a logging point of the controlled machine system.

8. An on-machine diagnostic logging system comprising:
interface circuitry for receiving control and monitoring signals from a motor controller that controls or monitor operation of a motor of a machine system;
a processor for receiving the control and monitoring signals from the interface and for processing the signals at least partially independently of a remote control and monitoring system; and
a memory circuit for storing the control and monitoring signals received by the processor;
wherein the logging system is configured as an independently operating module configured to be physically located proximate to the controller and local to the motor, and the interface circuitry is configured to be interrogated for access to control and monitoring signals stored in the memory circuit.

9. The system of claim 8, wherein a subset of the control and monitoring signals are transmitted to a remote control and monitoring system, and the diagnostic logging system receives and stores signals not part of the subset.

10. The system of claim 8, wherein the interface circuitry is configured to be coupled to a network and to monitor signals on the network for extraction of the control and monitoring signals to be stored in the memory circuit.

11. The system of claim 8, wherein the interface circuitry is coupled to a local access port for extraction of the control and monitoring signals to be stored in the memory circuit locally via the local access port.

12. The system of claim 8, wherein the interface circuitry is addressable via a network for remote access to the control and monitoring signals stored in the memory circuit.

13. The system of claim 8, wherein the interface circuitry is configured to receive analog control or monitoring signals applied to or sensed from a controlled machine system.

14. The system of claim 8, wherein the processor is configured to perform analysis of the received control and monitoring signals to determine fault or error conditions in the controlled machine system.

15. The system of claim 8, wherein the system is configured to log signals passively only, without communication of output or control signals to the controller.

16. An on-machine diagnostic logging system comprising:
a motor controller mounted locally to a controlled motor of a controlled machine system for controlling operation of the motor; and
a diagnostic logging module disposed physically proximate the motor controller and including interface circuitry for receiving control and monitoring signals from the motor controller, a processor for receiving the control and monitoring signals from the interface and for processing the signals at least partially independently of a remote control and monitoring system, and a memory circuit for storing the control and monitoring signals received by the processor;
wherein the logging module operates independently of the motor controller, and the interface circuitry is configured to be interrogated for access to control and monitoring signals stored in the memory circuit.

17. The system of claim 16, wherein the motor controller and the diagnostic logging module are disposed in a common enclosure.

18. The system of claim 16, wherein a subset of the control and monitoring signals are transmitted to a remote control and monitoring system, and the diagnostic logging module receives and stores signals not part of the subset.

19. The system of claim 16, wherein the interface circuitry is configured to be coupled to a network and to monitor signals on the network for extraction of the control and monitoring signals to be stored in the memory circuit.

20. The system of claim 16, wherein the interface circuitry is coupled to a local access port for extraction of the control and monitoring signals to be stored in the memory circuit locally via the local access port.
